(19) United States
(12) Patent Application Publication
(10) Pub. No.: US 2014/0217254 A1
(43) Pub. Date: Aug. 7, 2014

(54) MEDICAL MONITOR MOUNTING SYSTEM

(71) Applicant: MAQUET (SUZHOU) CO.,LTD., Suzhou (CN)

(72) Inventors: YUN ZHANG, Suzhou (CN); XIAOMING QIAN, Suzhou (CN); QINGXUE LI, Suzhou (CN); QUNHUA LI, Suzhou (CN); MING JI, Suzhou (CN)

(73) Assignee: MAQUET (SUZHOU) CO.,LTD., Suzhou (CN)

(21) Appl. No.: 14/257,988

(22) Filed: Apr. 21, 2014

Related U.S. Application Data
(63) Continuation of application No. PCT/CN2012/080706, filed on Aug. 2, 2013.

(30) Foreign Application Priority Data
Aug. 24, 2012 (CN) 201210302647.0
Aug. 24, 2012 (CN) 201210302648.5
Aug. 24, 2012 (CN) 201210302748.8
Aug. 24, 2012 (CN) 201210302822.6
Aug. 24, 2012 (CN) 201210302846.1
Aug. 24, 2012 (CN) 201210302848.0
Aug. 24, 2012 (CN) 201210302883.2
Aug. 24, 2012 (CN) 201210302902.1
Aug. 24, 2012 (CN) 201210302904.0
Aug. 24, 2012 (CN) 201210302977.X

(51) Int. Cl. F16M 11/04

(52) U.S. Cl. CPC F16M 11/043
USPC 248/298.1

(57) ABSTRACT

A monitor mounting system is provided. The monitor mounting system includes a supporting structure configured to be mounted at a location and to support the system and a frame formed by two first bars and two second bars. The monitor mounting system also includes a side bar with a sliding groove with a mounting member attached therein, wherein the mounting member slides along the sliding groove and attaches a monitor to the side bar. The monitor mounting system further includes a first attaching member configured to attach the side bar to the supporting structure.

### CROSS-REFERENCES TO RELATED APPLICATIONS

This application is a continuation International Patent Application Serial No. PCT/CN2012/080706 filed on Aug. 2, 2013, the entire contents of which are hereby incorporated by reference, which claims priority of Chinese Patent Applications 201210302647.0, 201210302648.5, 201210302748.8, 201210302822.6, 201210302846.1, 201210302848.0, 201210302883.2, 201210302902.1, 201210302904.0, and 201210302977.X, filed on Aug. 24, 2012, the entire contents of which are hereby incorporated by reference.

### FIELD OF INVENTION

This invention relates generally to medical devices and, more particularly, to medical monitor mounting systems.

### BACKGROUND

Medical monitors are high definition, high brightness monitors used in medical fields. With the development and popularization of picture archiving and communication system (PACS) and a variety of digital image devices, such as digital radiography, computed radiography, multi-slice computed tomography, and three-dimensional imaging, the choice of medical monitor becomes important for hospitals and PACS developers. Medical monitor is the final presenter of the medical image in the digital system and takes over the roles of film. The medical monitor ensures the quality of images to enable the observation and diagnosis of the physician. Medical monitors are usually high-priced. Thus, it is desirable to offer better protection to medical monitors.

Currently available medical monitor mounts have certain disadvantages. First, the mounting devices do not have back cover. As a result, the power cords and other peripheral components are exposed, which may be unsafe and may collect dust to affect the use of the monitor. Second, the currently available mounts are suitable to mount monitors with fixed number and size. When the number and size of the monitors change, new mount need to be manufactured, increasing the cost and wasting man power and materials. Third, the mounts are vulnerable to deformation and damages when the mounts receive external force. As a result, the images on the monitors may become unstable. The monitors may even fall from the mounts. The use of monitors may thus be affected. The effective working time may be reduced and the working efficiency may also be reduced, which in turn may increase the cost of the hospital. Fourth, the monitors may not turn around after mounting. The observing angle of the monitors may not be adjusted and there may be some blind spots for observation. Using the mount may affect a physician's observation and diagnosis of a patient. In addition, there may be gaps with noticeable size between monitors. Dust may accumulate on the monitors, which may cause hygiene concern and may also negatively affect the appearance of the monitors.

The disclosed medical monitor mounting systems are directed at solving one or more problems set forth above and other problems.

### BRIEF SUMMARY OF THE DISCLOSURE

One aspect of the present disclosure provides a monitor mounting system. The monitor mounting system includes a supporting structure configured to be mounted at a location and to support the system and a frame formed by two first bars and two second bars. The monitor mounting system also includes a side bar with a sliding groove with a mounting member attached therein, wherein the mounting member slides along the sliding groove and attaches a monitor to the side bar. The monitor mounting system further includes a first attaching member configured to attach the side bar to the supporting structure.

Another aspect of the present disclosure provides a monitor mounting system. The monitor mounting system includes a supporting structure configured to be mounted at a location and to support the system and a frame formed by two first bars and two second bars. The monitor mounting system also include a side bar with a mounting member disposed at an end of the side bar, wherein the mounting member includes a first attaching member and a first positioning member. The monitor mounting system further includes a second attaching member configured to attach the side bar to the supporting structure. The first attaching member includes two first supporting members, a second supporting member perpendicular to the first supporting member. A hanging structure and a recess are disposed on the first supporting members. The positioning member is attached to the side bar at a first end of the positioning member, and contacts the hanging structure at a second end of the positioning member.

Another aspect of the present disclosure provides a monitor mounting system. The monitor mounting system includes a supporting structure configured to be mounted at a location and to support the system and a frame formed by two first bars and two second bars. The monitor mounting system also includes two side bars attached to the supporting structure. The monitor mounting system further includes a movable mounting member disposed at an end of the side bar. The monitor mounting system also includes a back cover with two covers disposed between the second bars.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary medical monitor mounting system consistent with the disclosed embodiments;

FIG. 2 illustrates exemplary side bars and mounting members consistent with the disclosed embodiments;

FIG. 3 illustrates an exemplary attaching structure consistent with the disclosed embodiments;

FIG. 4 illustrates an exemplary frame with a back cover in opening status;

FIG. 5 illustrates an exemplary mounting system consistent with the disclosed embodiments;

FIG. 6 illustrates an exemplary side and mounting members consistent with the disclosed embodiments;

FIG. 7 illustrates a front view of an exemplary side bar with the mounting member assembled thereon;

FIG. 8 illustrates a side view of an exemplary side bar with the mounting member assembled thereon;

FIG. 9 illustrates a back view of an exemplary side bar with the mounting member assembled thereon;

FIG. 10 illustrates an exemplary mounting system consistent with the disclosed embodiments;

FIG. 11 illustrates an exemplary side bar and an exemplary mounting member consistent with the disclosed embodiments;

FIG. 12 illustrates an exemplary monitor attaching member and an exemplary angle adjusting member consistent with the disclosed embodiments;

FIG. 13 illustrates the side view of an exemplary angle adjusting member with an exemplary monitor attaching member assembled thereon;

FIG. 14 illustrates the bottom view of an exemplary angle adjusting member with an exemplary monitor attaching member assembled thereon;

FIG. 15 illustrates an exemplary side bar with exemplary mounting member assembled thereon;

FIG. 16 illustrates an exemplary mounting system with monitors assembled thereon;

FIG. 17 illustrates an exemplary side bar with monitors assembled thereon;

FIG. 18 illustrates an exemplary spatial relationship of six monitors as assembled on the mounting system;

FIG. 19 illustrates an exemplary mounting system consistent with the disclosed embodiments;

FIG. 20 illustrates an exemplary side bar and an exemplary mounting member assembled thereon; and

FIG. 21 illustrates an exemplary frame 2 consistent with the disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

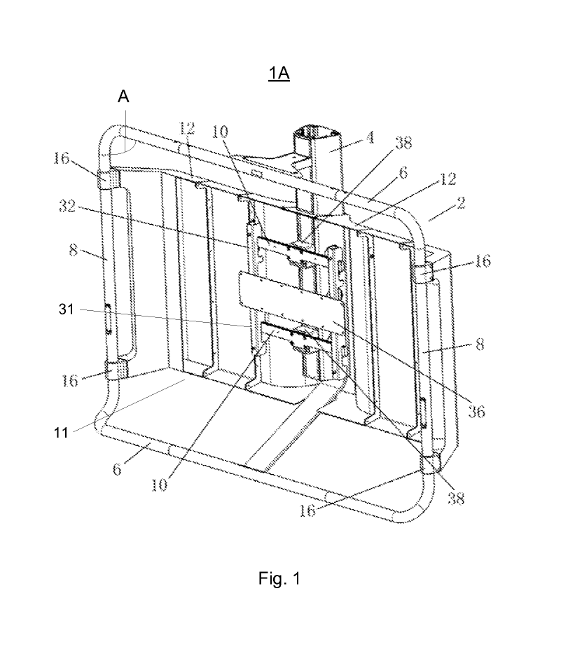

FIG. 1 illustrates an exemplary medical monitor mounting system 1A consistent with the disclosed embodiments. As shown in FIG. 1, the system 1A may include a frame 2 and a supporting structure 4. The supporting structure 4 is configured to support the system 1A and to mount the system 1A to any appropriate location. For example, the supporting structure 4 may be mounted to a wall and the frame 2 and other component of the system 1A may be attached to the structure 4. The supporting structure 4 may also be mounted on any other appropriate location and/or device. In certain embodiments, the supporting structure 4 may be a shaft with sufficient strength to support the system 1A and the monitors attached thereon. The supporting structure 4 may also be any other appropriate structure.

The frame 2 may be formed by two first bars 6 along first dimension, two second bars 8 along second dimension. A back cover 11 may be attached to the two second bars 8. In certain embodiments, the back cover 11 may be formed by two covers 12, with each cover 12 attached to one second bar 8.

Two side bars 10 may be attached to the supporting structure 4 through an attaching member 38. The attaching member 38 may be configured to attach the side bar 10 securely to the supporting structure 4. The attaching member 38 may have sufficient strength to support the weight of the side bar 10 and other components and/or monitors assembled thereon. Two movable mounting members 31 may be disposed at the two ends of the side bars 10. The two mounting member 31 may be connected through a monitor attaching member 36. In certain embodiments, the two side bars 10 are parallel to each other.

In certain embodiments, the first bars 6 are disposed horizontally and the second bars 8 are disposed vertically. The first bars 6 and the second bars 8 may be disposed at any appropriate dimension. An angle A may be formed between one first bar 6 and one second bar 8. In certain embodiments, the angle A is 90°. The angle A may also be any appropriate value.

The supporting structure 4, the first bars 6, the second bars 8, the side bar 10, the cover 11, the mounting member 31, the monitor attaching member 36, and the attaching member 38 and other components of the mounting system 1A may be made of any appropriate materials. The materials may be sufficiently strong to bear the weight of the monitor mounted on the system 1A. The materials may also be sufficiently light for the transportation of the system 1A. For example, the material may be aluminum, alloy, plastic, or any other appropriate materials. Each component of the system 1A may or may not be made of same material.

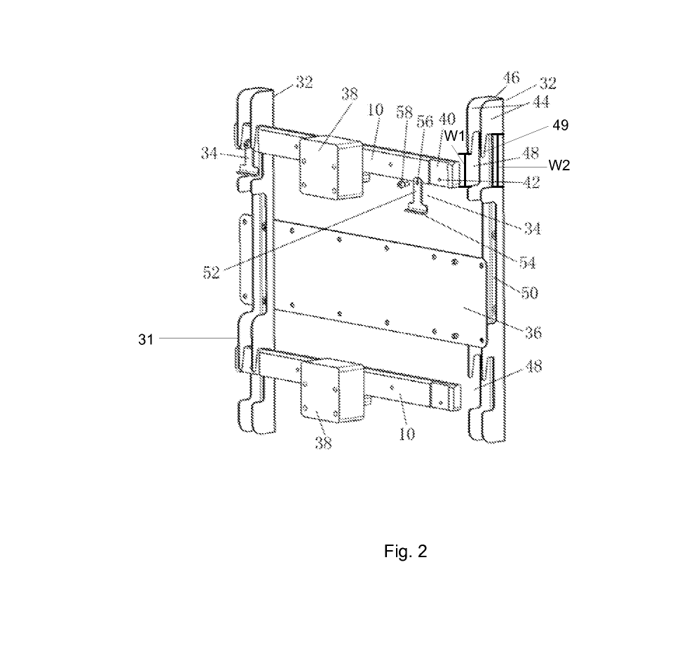

FIG. 2 illustrates exemplary side bars 10 and mounting members 31 consistent with the disclosed embodiments. As show in FIG. 2, a positioning structure 40 may be disposed at the end of the side bar 10 to allow the mounting member 31 to be attached to the side bars 10. In certain embodiments, the positioning structure 40 is an indentation. The positioning structure 40 may also be any other appropriate structure to allow the mounting member 31 to be attached to the side bars 10. A fastener receiving structure 42 may be located in the positioning structure 40 to receive a fastener 58. In certain embodiments, the fastener 58 is a threaded bolt and the receiving member 42 is an opening on the mounting structure 40 with thread that matches the thread on the fastener 58. The fastener 58 and the fastener receiving structure 42 may also be any other appropriate mechanism.

The mounting member 31 may include an attaching member 32 and a positioning member 34. In certain embodiments, the attaching member 32 may be an elongated bar with a U shape cross section. The attaching member 32 may also be in any other appropriate shape. As shown in FIG. 2, the attaching member 32 may include a first supporting member 44 and a second supporting member 46. In certain embodiments, the first supporting member 44 and the second supporting member 46 may form a rectangle. The first supporting member 44 and the second supporting member 46 may form any appropriate angle. The attaching member 32 may also include an additional first supporting member 44. Thus, the two first supporting members 44 and the second supporting member 46 may form a U shape cross section. The supporting member 44 and the supporting member 46 may form any appropriate shape cross section.

A hanging structure 48 may be disposed on the first supporting member 44. In certain embodiments, the hanging structure 48 may be a hook shaped recess with a hook point 49 on the supporting member 44. The hanging structure 48 may have a first dimension W1 at the opening and a second dimension W2 at the base. In certain embodiments, the dimension W2 is greater than the dimension W1. The hanging structure 48 may also be other appropriate structure. A recess 50 may be disposed on the supporting member 44.

The positioning member 34 may be configured to limit the movement of the attaching member 32 after the attaching member 32 is attached to the positioning structure 40. The positioning member 34 may include a first part 52. In certain embodiments, the first part 52 may have a top portion and a bottom portion. Both the top and the bottom portion may be in the shape of a rectangle and the top portion is smaller than the bottom portion. In another word, the first part 52 may be in a shape of a Chinese character “ [symbol] .” The first part 52 may also be in any appropriate shape. An opening 56 may be disposed at an appropriate position of the first part 52. In certain embodiments, the opening 56 may be on the top of the positioning member 34. The opening 56 may be configured to allow the fastener 58 to pass through the first part 52 to be received by the fastener receiving structure 42 to attach the positioning member 34 to the positioning structure 40.

The positioning member 34 may also include a second part 54. The second part 54 may be located at the bottom of the first part 52 and may form any appropriate angle with the first part 52. In certain embodiments, the second part 54 may be perpendicular to the first part 52.

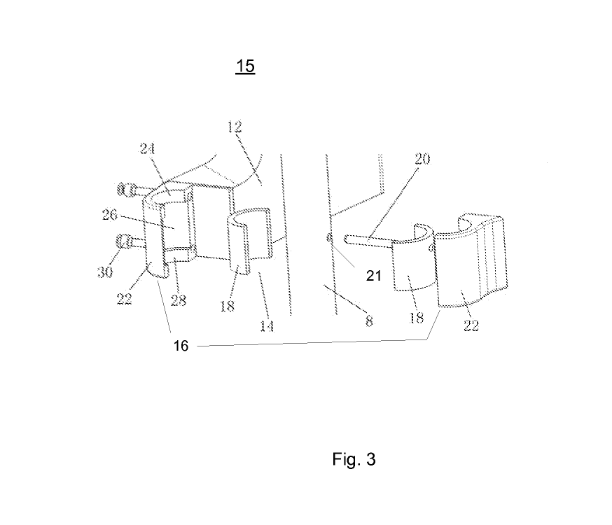

FIG. 3 illustrates an exemplary attaching structure 15 consistent with the disclosed embodiments. The attaching structure 15 may be configured to attach the cover 12 to the second bar 8. As shown in FIG. 3, the attaching structure 15 may include a first contacting sheath 14 and a second contacting sheath 16. The first contacting sheath 14 may include two inner half sheaths 18. The two inner half sheaths 18 may cover the second bar 8. In certain embodiments, the inner half sheath 18 may be in the shape of semi-circle and the contacting sheath 14 may be in the shape of circle. A hinge pin 20 may be disposed on the inner half sheath 18. The hinge pin 20 may be configured to pass through an opening 21 on the second bar 8 to attach the contacting sheath 14 to the second bar 8.

The second contacting sheath 16 may include two outer half sheaths 22. In certain embodiments, the outer half sheath 22 may be in the shape of a semi-circle so the second contacting sheath 16 may be in the shape of a circle. The half sheath 22 and the outer sheath 18 may also be in any other appropriate shape. As shown in FIG. 3, the inner side of the half sheath 22 may include an upper portion 24, a middle portion 26, and the bottom portion 28. The upper portion 24, the middle portion 26, and the bottom portion 28 may be configured to allow the inner half sheath 18 to be disposed in the outer half sheath 22. In certain embodiments, the middle portion 26 may be a recess on the inner side of the outer half sheath 22. The inner half sheath 18 may fit into the recess 26. The upper portion 24 and the bottom portion 28 may support the inner half sheath 18 and may restrict the movement of the inner half sheath 18. A fastener 30 may attach two half sheath 22. The second contacting sheath 16 may rotate around the first contacting sheath 14.

Referring to FIGS. 1-3, FIG. 1 illustrates an exemplary mounting system 1A after assembling. To assemble a mounting system 1A, two attaching members 38 may be attached to the supporting structure 4. The two side bars 10 may be attached to the attaching members 38. The attaching member 32 may be attached to the side bar 10 with the hanging structure 48 disposed on the positioning structure 40. The fastener 58 may attach the positioning member 34 through the opening 56 to the side bar 10 by fastening to the fastener receiving structure 42. The second part 54 of the positioning member 34 may be configured to touch the bottom of the hanging structure 48. The monitor attaching member 36 may be attached to the two second supporting member 46. The monitor may be attached to the monitor attaching member 36.

The two half sheaths 18 may cover the second bar 8 and may attach to the second bar 8 through the hinge pin 20. The sheath 18 may be disposed in the middle portion 26 of the half sheath 22. The fastener 30 may attach the two half sheaths 22. The back cover 11 may be disposed between the two second bars 8. The second part 54 of the positioning member 34 restricts the up movement of the attaching member 32. The side bar 10 restricts the down movement of the attaching member 32. The positioning structure 40 restricts the horizontal movement of the attaching member 32. Thus, the movement of the attaching member 32 is limited, which prevents the falling of the medical monitor together with the attaching member 32 from the side bar 10.

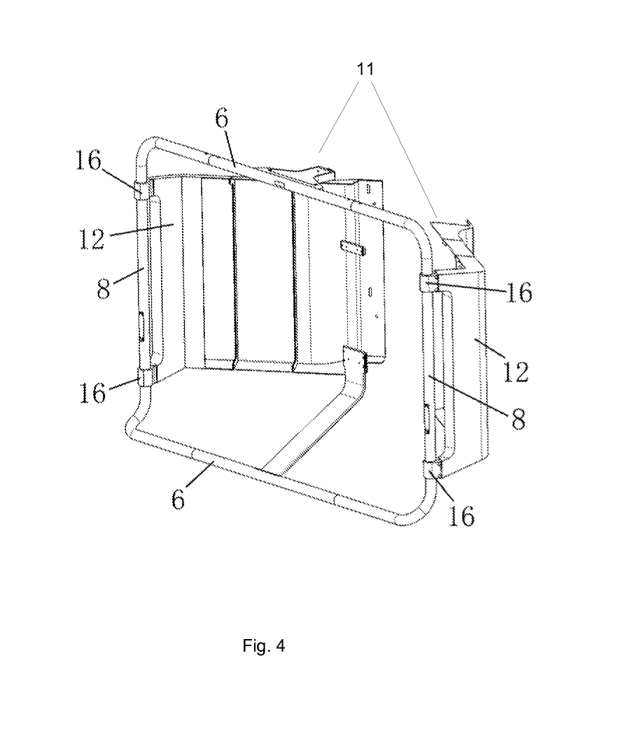

FIG. 4 illustrates an exemplary frame 2 with a back cover in opening status. When it is necessary to open the back cover 11, the cover 12 may rotate around the second bar 8 through the rotation of the second sheath 16 around the first sheath 14 to open the back cover 11.

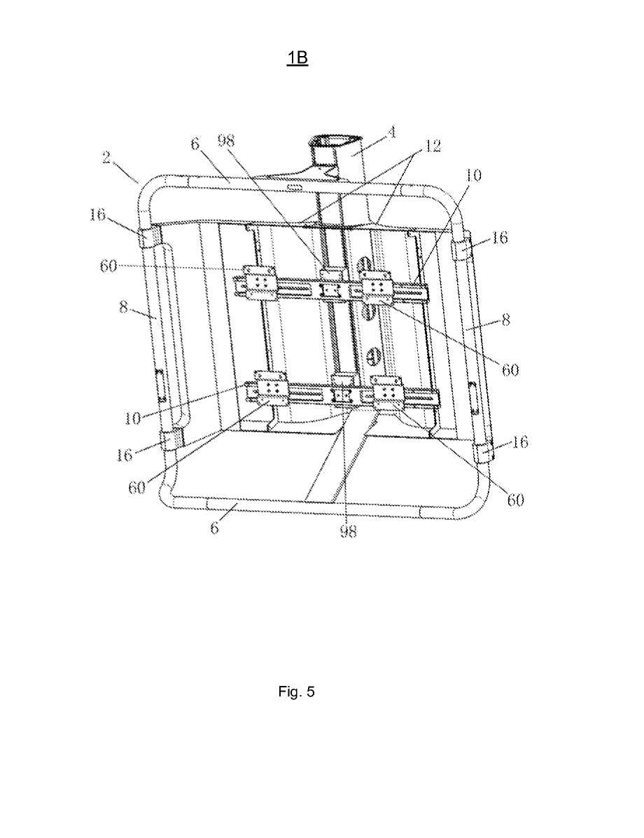

FIG. 5 illustrates an exemplary mounting system 1B consistent with the disclosed embodiments. As shown in FIG. 5, the system 1B includes the frame 2, the supporting structure 4, and the back cover 11. The system 1B may also include a side bar 10, an attaching member 98, and a mounting member 60. The frame 2, the supporting structure 4, and the back cover 11 and the components thereof may be similar to those of the system 1A.

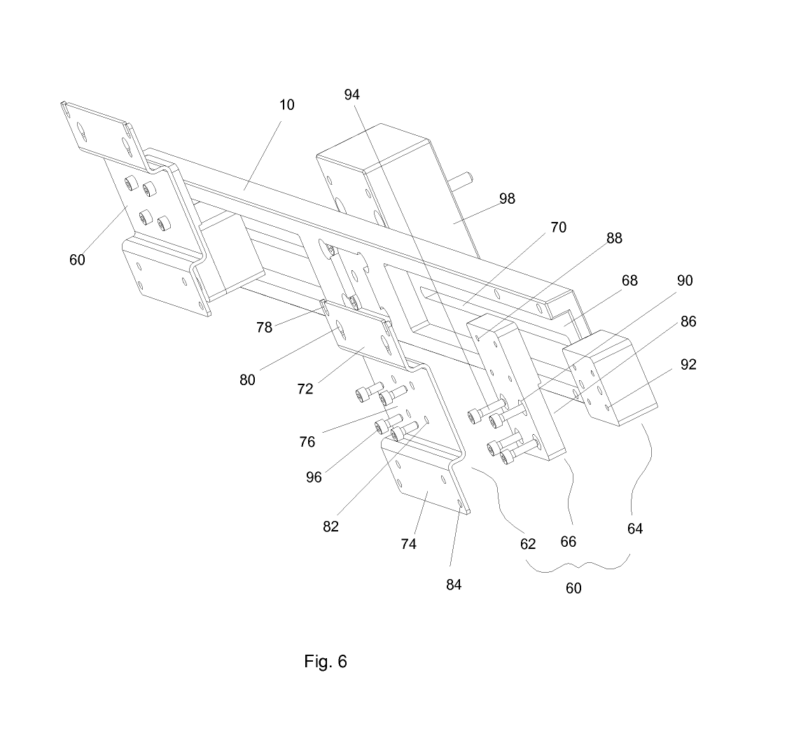

FIG. 6 illustrates an exemplary side 10 and mounting members 60 consistent with the disclosed embodiments. As shown in FIG. 6, a mounting member 60 may include a monitor attaching member 62, a sliding member 64 and a middle member 66. The sliding member 64 may slide along the side bar 10. The side bar 10 may include a sliding groove 68 and an opening 70 disposed at the back wall of the side bar 10. The sliding groove 68 may be configured to allow the sliding member 64 to slide therein. In certain embodiments, two sliding grooves 68 may be longitudinally disposed on the two ends of the side bar 10 symmetrically. The length of the sliding groove 68 may be adjusted and determined empirically. In certain embodiments, the opening 70 may be an elongated opening.

The monitor attaching member 62 may include a first part 72, a second part 74, and a third part 76. The first part 72 is configured to attach a monitor and the second part 74 is configured to attach the monitor attaching member 62 to the middle member 66. In certain embodiments, the cross section of the first part 72 may be L shaped, the cross section of the second part 74 may also be L shape with a reverse orientation to the first part 72, and the third part 76 may connect the first part 72 and the second part 74. The first part 72 and the second part 74 may also be in any appropriate shapes.

A groove 78 may be disposed on the top of the first part 72. In certain embodiments, the groove 78 may be in the shape of letter “U.” The groove 78 may also be in any other appropriate shape. An opening 80 may be disposed on the first part 72. In certain embodiments, the opening 80 may have an upper portion and lower portion with the upper portion being larger. The upper portion and the lower portion may be in a shape of circle. The upper portion and the lower portion may be in any appropriate shape. The opening 80 may be in any appropriate shape. An opening 82 may be disposed on the third part 76 and an opening 84 may be disposed on the second part 74. The groove 78, the opening 80, and the opening 84 may be configured to receive an attaching structure on the medical monitor to securely attach the monitor to the monitor mounting member 60.

A coupling structure 86 may be disposed on the one side of the middle member 66. The coupling structure 86 may be configured to couple the middle member 66 and the sliding member 64. On the other side of the middle member 66, a fastener receiving structure 88 may be located on the upper portion of the middle member 66. An opening 90 may be located on the lower portion of the middle member 66. A fastener receiving structure 92 may be disposed on the sliding member 64.

The sliding member 64 may be coupled to the middle member 66 by fitting in the coupling structure 86. A fastener 94 may attaching the middle member 66 and the sliding member 64 by passing through the opening 90 and fastening to the fastener receiving structure 92. In certain embodiments, the fastener 94 is a threaded bolt and the fastener receiving structure 92 is an opening with thread that matches the thread on the fastener 94. Any other appropriate fastener and fastener receiving mechanism may also be used.

The monitor attaching member 62 may be attached to the middle member 66. A fastener 96 may pass through the opening 82 and fasten to the fastener receiving structure 88. In certain embodiments, the fastener 96 is a threaded bolt and the receiving structure 88 is an opening with thread that matches the thread on the fastener 96. Any other appropriate fastener and fastener receiving mechanism may also be used.

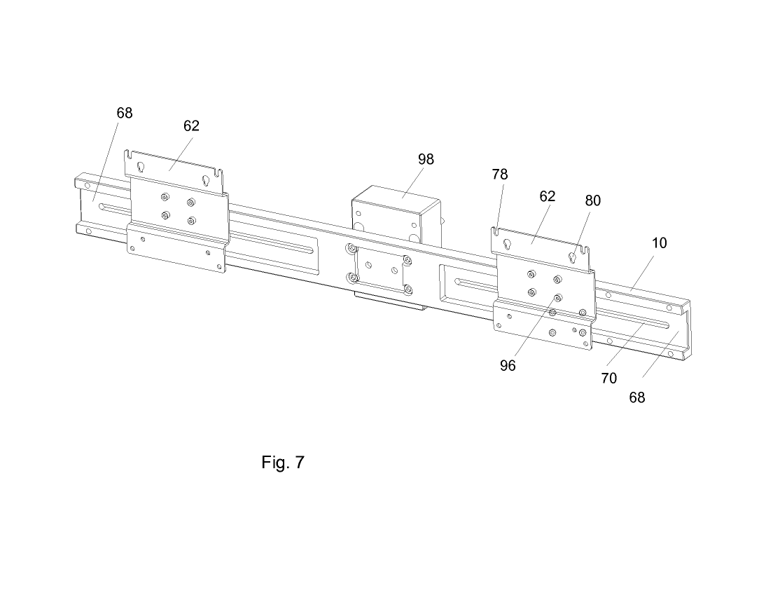

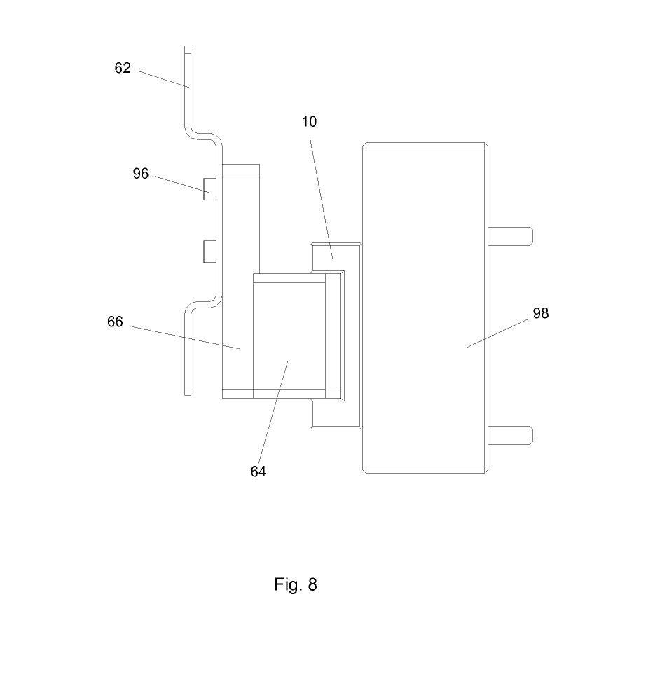

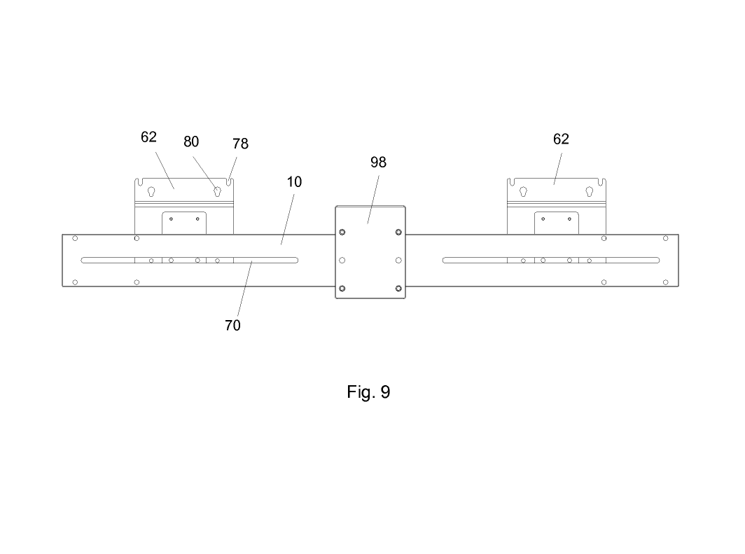

FIG. 7 illustrates a front view of an exemplary side bar 10 with the mounting member 60 assembled thereon. FIG. 8 illustrates a side view of an exemplary side bar 10 with the mounting member 60 assembled thereon. FIG. 9 illustrates a back view of an exemplary side bar 10 with the mounting member 60 assembled thereon. As shown in FIGS. 6 to 9, the sliding member 64 may be attached to the side bar 10 through the opening 70. The middle member 66 may be attached to the sliding member 64. The mounting member 62 may be attached to the middle member 66. A medical monitor may be attached to the first part 72 of the mounting member 62. The assembling of the cover 11 to the second bar 8 is similar to the assembling of the cover to the second bar 8 in system 1A. The side bar 10 may be attached to the attaching member 98, which may be subsequently attached to the supporting structure 4. The attaching member 98 may be configured to attach the side bar 10 securely to the supporting structure 4. The attaching member 98 may have sufficient strength to support the weight of the side bar 10 and other components and/or monitors assembled thereon.

When the width of the medical monitor changes, the sliding member may be adjusted. The sliding member 64 may be detached from the opening 70 of the side bar 10. The sliding member 64 may slide along the sliding groove 68. When the two sliding member 64 are adjusted to an appropriate distance, that is, when two monitors may be disposed within the frame 2, the sliding member 64 may be attached to the opening 70 of the side bar 10. Four monitors may be arranged in the frame 2. When it is necessary to open the back cover 11, the cover 12 may rotate around the second bar 8 through the rotation of the second sheath 16 around the first sheath 14 to open the back cover 11.

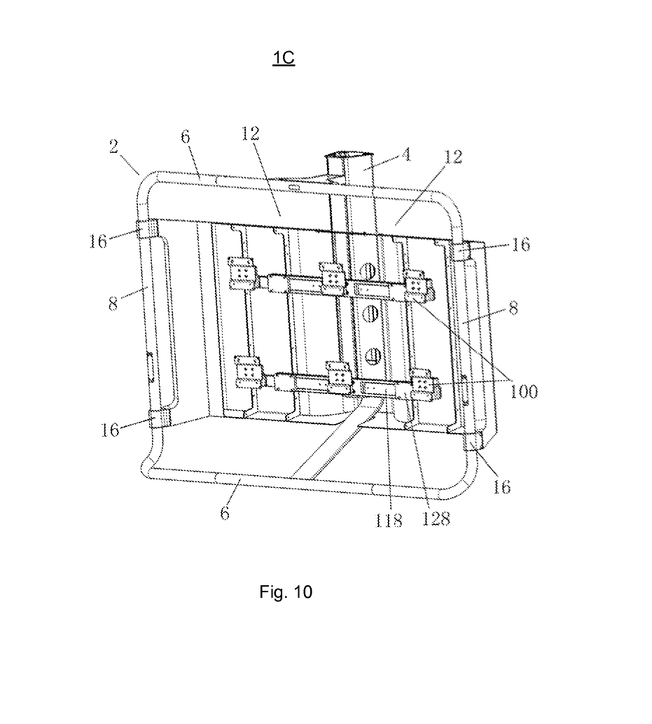

FIG. 10 illustrates an exemplary mounting system 1C consistent with the disclosed embodiments. As shown in FIG. 10, the system 1C may include the frame 2, the supporting structure 4, the side bar 10, and a mounting member 100. The frame 2 and the supporting structure 4 may be similar to these in the system 1A.

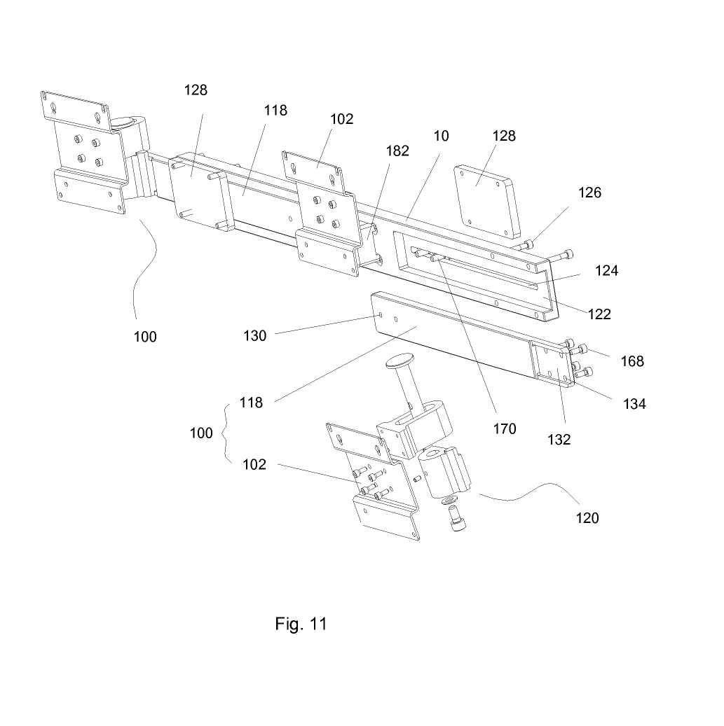

FIG. 11 illustrates an exemplary side bar 10 and an exemplary mounting member 100 consistent with the disclosed embodiments. As shown in FIG. 11, the mounting member 100 may include a monitor attaching member 102, a sliding member 118 and an angle adjusting member 120.

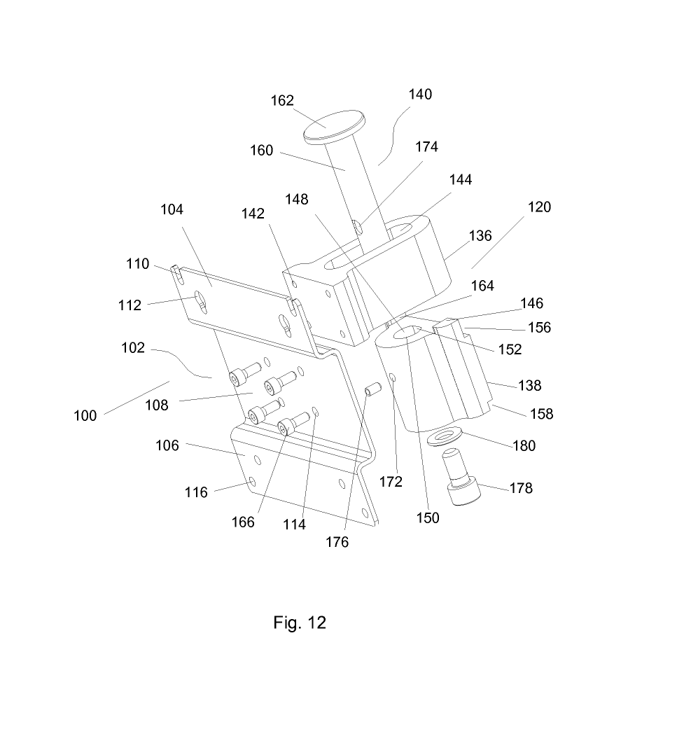

FIG. 12 illustrates an exemplary monitor attaching member 102 and an exemplary angle adjusting member 120 consistent with the disclosed embodiments. As shown in FIG. 12, the monitor attaching member 102 may include a first part 104, a second part 106, and a third part 108. In certain embodiments, the cross section of the first part 104 may be in the shape of letter “L.” The cross section of the second part 106 may also be in the shape of letter “L” with a reverse orientation to the first part 104. The first part 104 and the second part 106 may also be in any other appropriate shape. The third part 108 may connect the first part 104 and the second part 106. A groove 110 may be disposed on the top of the first part 104. In certain embodiments, the groove 110 may be in the shape of “U.” The groove 110 may also be in any other appropriate shape. An opening 112 may be disposed on the first part 104. In certain embodiments, the opening 112 may have an upper portion and lower portion with the upper portion being larger. The upper portion and the lower portion may be in a shape of circle. The upper portion and the lower portion may be in any appropriate shape. The opening 112 may be in any appropriate shape. An opening 114 may be disposed on the third part 108 and an opening 116 may be disposed on the second part 106.

Returning to the FIG. 11, the sliding member 118 may be in the shape of an elongated rectangle. The sliding member 118 may also be in any other appropriate shape. The sliding member 118 may be configured to fit in a sliding groove 122 disposed on the side bar 10 and may slide thereon. In certain embodiments, two sliding grooves 122 may be disposed longitudinally on the two ends of the side bar 10 symmetrically. The length of the sliding grooves 122 may be adjusted and determined empirically. An opening 124 may be disposed at the back side of the groove 122. In certain embodiments, the opening 124 may be an elongated opening. The opening 124 may be in any appropriate shape. A monitor mounting member 102 may be disposed at the center of the side bar 10, attaching to an attaching member 182. The attaching member 182 may be configured to attach the side bar 10 securely to the supporting structure 4. The attaching member 182 may have sufficient strength to support the weight of the side bar 10 and other components and/or monitors assembled thereon.

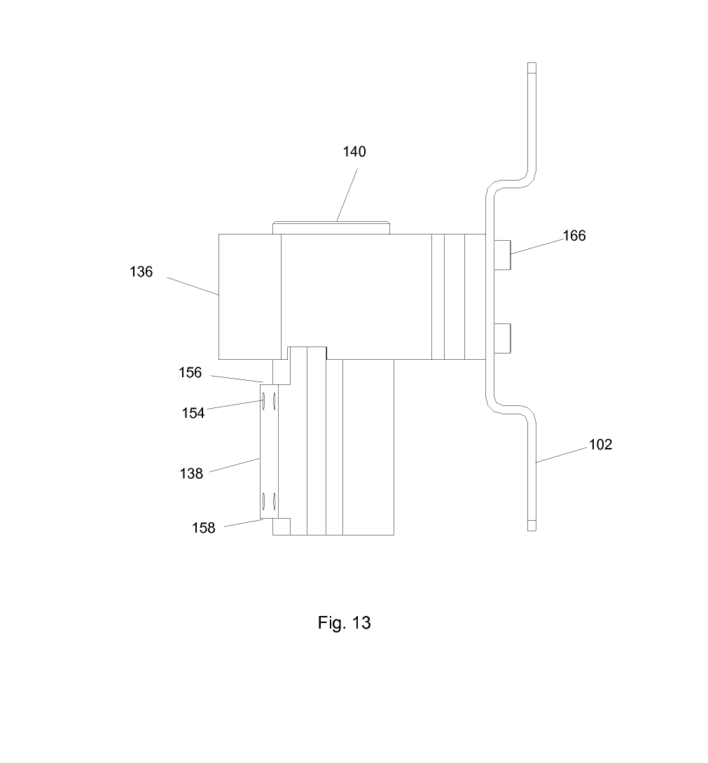

The sliding member 118 may have an opening 130 disposed at the end close to the center of the side bar 10. The opening 130 may receive a fastener 170 through the opening 124 to fix the sliding member 118 at a position along the sliding groove 122. An attaching structure 134 may be disposed on the end further from the center on the sliding member 118. In certain embodiments, the attaching structure 134 may be a recess on the sliding member 118 with opening 134. A fastener 168 may attach the angle adjusting member 120 by passing through the opening 134 and fastening into a receiving structure 154 on the angle adjusting member 120 (see FIG. 13).

A protective member 128 may be disposed on the side bar 10. As shown in FIG. 11, the protective member 128 may be disposed at the end on the side bar 10 further away from the center of the side bar 10. The protective member 128 may be located in any appropriated position. The protective member 128 may be attached to the side bar 10 by a fastener 126. In certain embodiments, the fastener 126 may be a threaded bolt. The fastener 126 may also be any appropriate mechanism that can fasten the protective member 128.

As shown in FIG. 12, the angle adjusting member 120 may include an upper portion 136, a lower portion 138, and a rotating member 140. A fastener receiving member may be disposed on a front end of the upper portion 136. An opening 144 may be disposed at the middle of the upper portion 136. In certain embodiments, the cross section of the opening 144 may be elongated. The cross section of the opening 144 may be in any appropriate shape.

The lower portion 138 may include a platform 146 on the top. At the back side of the lower portion 138, a platform 156 may be formed on the top and a platform 158 may be formed at the bottom. A passage 148 may be disposed at the center of the lower portion 138. The wall of the passage 148 may include a first surface 150 and a second surface 152. In certain embodiments, the first surface 150 may be an arc surface and the second surface 152 may be a flat surface. The first surface 150 and the second surface 152 may also be in any other appropriate shape.

The rotating member 140 may include a shaft 160. In certain embodiments, the shaft 160 may include an upper section and a lower section. The cross section of the upper section of the shaft 160 may be in the shape of a circle. The cross section of the lower section of the shaft 160 may be configured to match the shape of the cross section of the passage 148, that is, a part of the cross section of the lower section of the shaft 160 may match the first surface 150 and a part of the cross section of the lower section of the shaft 160 may be a surface 164 that matches the second surface 152. In certain embodiment, the surface 164 may be a flat surface. Thus, the shaft 160 may not rotate relative to the lower portion 138. The shaft 160 may be in any other appropriate shape. A disc 162 may be disposed on the top of the shaft 160. The disc 162 may be in a shape of a circle. The disc 162 may also be in any appropriate shape.

In certain embodiments, it may be desirable to fix the shaft 160 to the lower portion 138. To further secure the shaft 160, an opening 172 may be disposed on the front side of the lower portion 138. An opening 174 may be disposed on the front side of the shaft 174. A hinge pin 176 may be disposed in both the openings 172 and 174 to secure the shaft 160. In certain embodiments, a fastener 178 may be used to further secure the shaft 160 to the lower portion 138. The fastener 178 may pass through a washer 180 to fasten the 160 at the bottom. In certain embodiments, the fastener 178 may be a threaded bolt. The fastener 178 may also be any other appropriate fastening mechanism.

FIG. 13 illustrates the side view of an exemplary angle adjusting member 120 with an exemplary monitor attaching member 102 assembled thereon. As shown in FIG. 13, the back of the lower portion 138 may be a substantially flat surface. The back of the lower portion 138 may also be in any other appropriate shape. The top of the lower portion 138 may be indented to form the platform 156 and the bottom of the lower portion 138 may be indented to form the platform 158. A fastener receiving member 154 may be disposed at the back side of the lower portion 138.

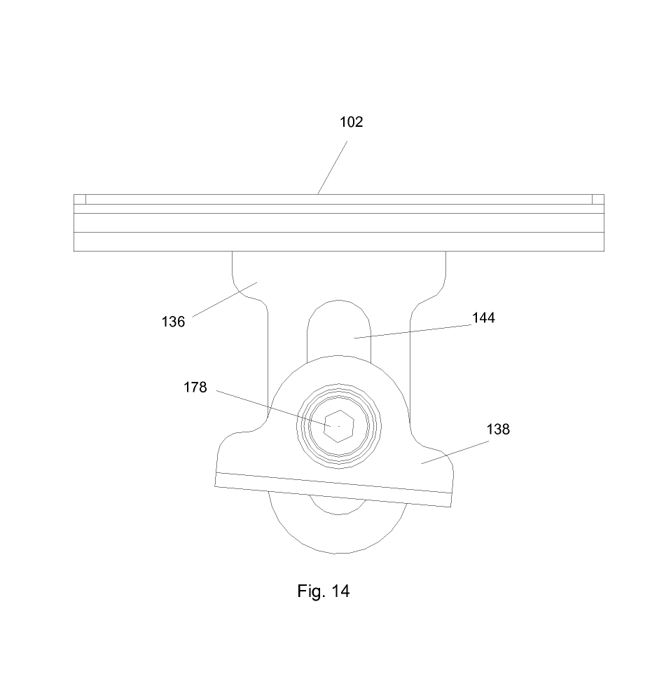

FIG. 14 illustrates the bottom view of an exemplary angle adjusting member 120 with an exemplary monitor attaching member 102 assembled thereon. As shown in FIG. 14, the fastener 178 may secure the shaft 160 to the lower portion 138 by fastening the bottom of the shaft 160.

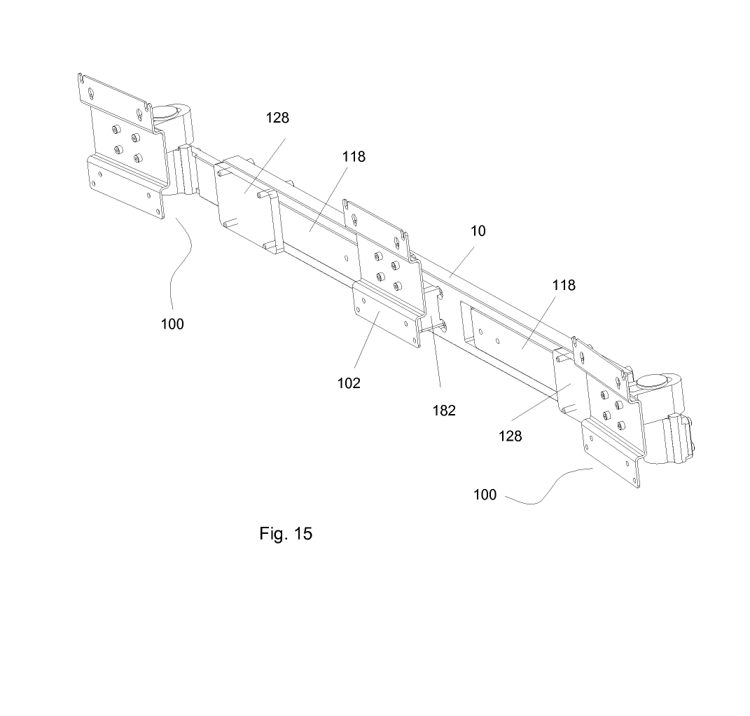

FIG. 15 illustrates an exemplary side bar 10 with exemplary mounting member 100 assembled thereon. Referring to FIGS. 11-13, the monitoring attaching member 102 may be attached to the upper portion 136 by fastening the fastener 166 to the fastener receiving member 142. The lower portion 138 may be attached to the sliding member 118 by fastening the fastener 168 to the fastener receiving member 154. The sliding member 118 may be attached to the side bar 10 by fastening the fastener 170 to the fastener receiving member 130. The fastener 170 may pass through the opening 124. In certain embodiments, the fasteners 166, 168, and 170 may be threaded bolts and the fastener receiving members 130, 142, and 154 may be openings with thread that matches the thread on the corresponding fastener.

Referring to FIGS. 10 and 11, to use the mounting system 1C, the side bar 10 may be attached to the supporting structure 4. The sliding member 118 may be disposed in the sliding groove 122. The sliding member 118 may be secured to the side bar 10 by fastening the fastener 170 to the fastener receiving member 130. The monitor attaching member 102 may be attached to the upper portion 136. The shaft 160 may be disposed in the passage 144 and secured to the lower portion 138. The lower portion 138 may be attached to the sliding member 118. The assembling of the back cover 12 to the frame 2 may be similar to that in the mounting system 1A.

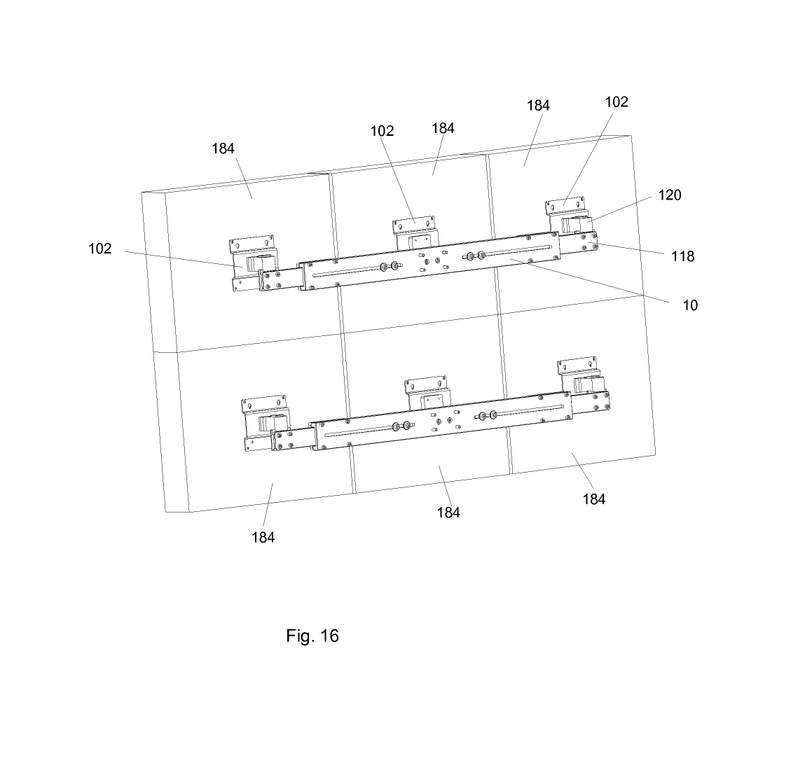

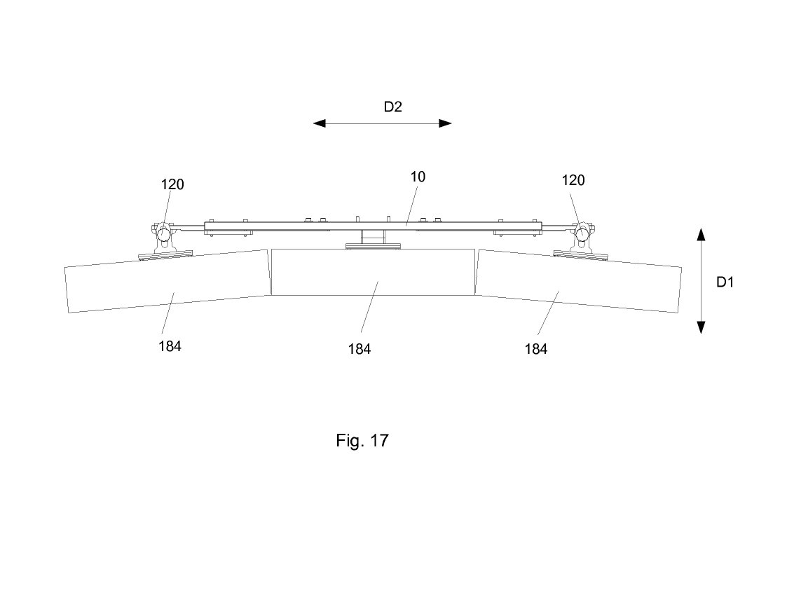

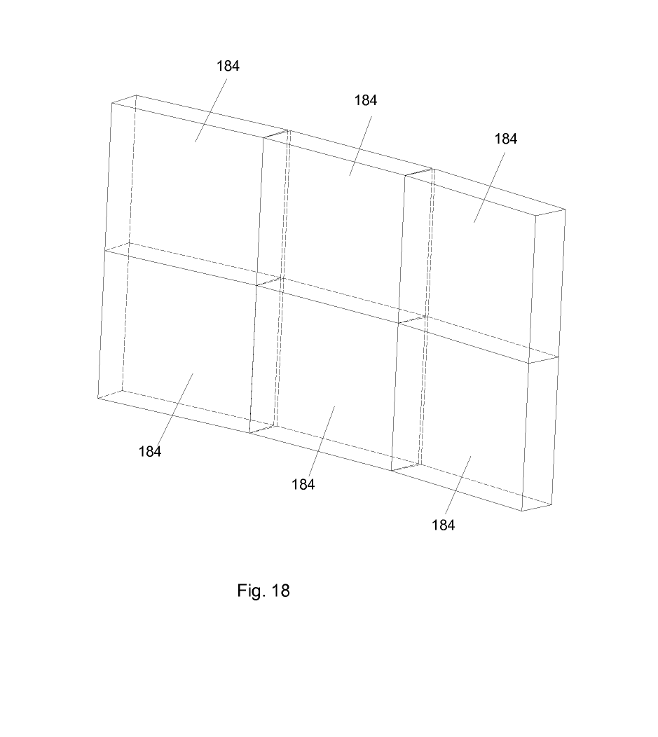

FIG. 16 illustrates an exemplary mounting system 1C with monitors 184 assembled thereon. FIG. 17 illustrates an exemplary side bar 10 with monitors 184 assembled thereon. FIG. 18 illustrates an exemplary spatial relationship of six monitors 184 as assembled on the mounting system 1C. As shown in FIGS. 16-18, the monitor 184 that is located in the middle may remain at its position. The position and orientation of the monitors 184 located at outside may be adjusted. As shown in FIG. 17, the monitor 184 on the outside may be moved along the D2 dimension by moving the sliding member 118. The angle of the monitor 184 on the outside relative to the D2 dimension may be adjusted by rotating the upper portion 136 around the shaft 160 of the rotating member 140. Line contact between the side of the outside monitor 184 and the side of the central monitor 184 may be achieved. The view field mosaic gap between the outside 184 and the central monitor 184 may be reduced.

Returning to FIG. 10, the back cover 12 may be opened as illustrated in FIG. 4.

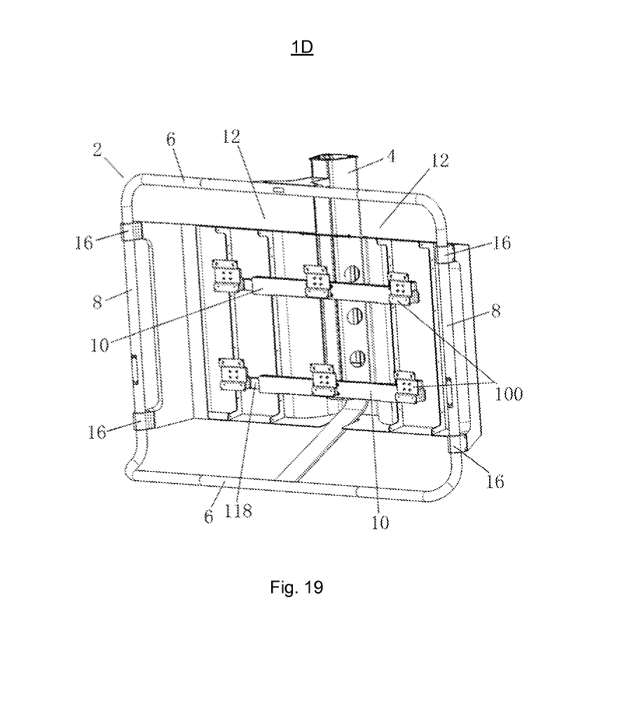

FIG. 19 illustrates an exemplary mounting system 1D consistent with the disclosed embodiments. As shown in FIG. 19, the system 1D may include a frame 2, a supporting structure 4, and a side bar 10. The frame 2, the supporting structure 4, and the side bar 10 may be similar to those as described in system 1A.

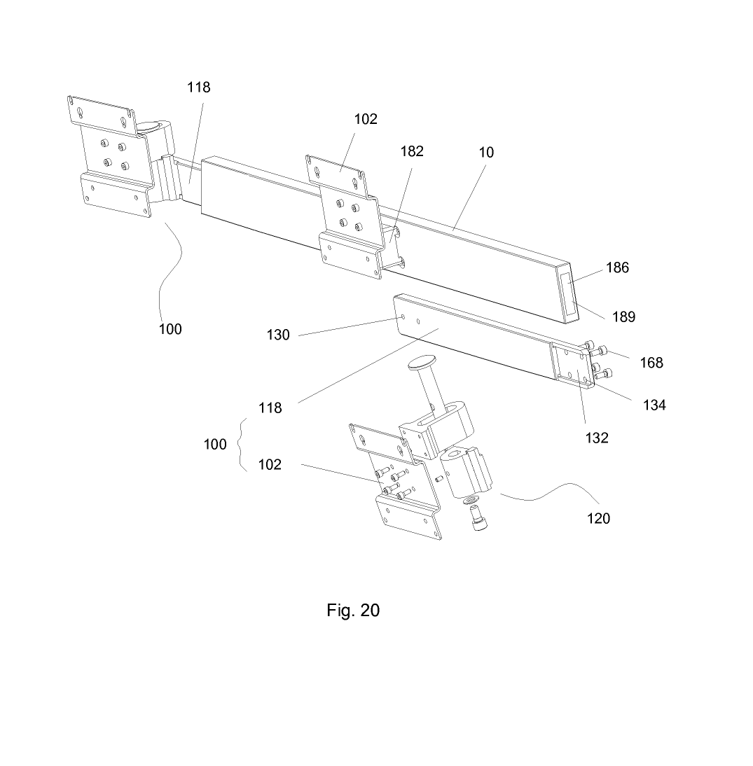

FIG. 20 illustrates an exemplary side bar 10 and an exemplary mounting member 100 assembled thereon. As shown in FIG. 20, the mounting member 100 is similar to that in system 1C. The side bar 10 may include a sliding chamber 186. The sliding chamber 186 may be an elongated enclosed chamber with an opening 189 to allow the sliding member 118 to be inserted into the chamber 186. The chamber 186 may be configured to allow the sliding member 118 to move therein. It is similar to use the system 1D as to use the system 1C. The sliding member 118 may be moved along the sliding chamber 186 to change the position.

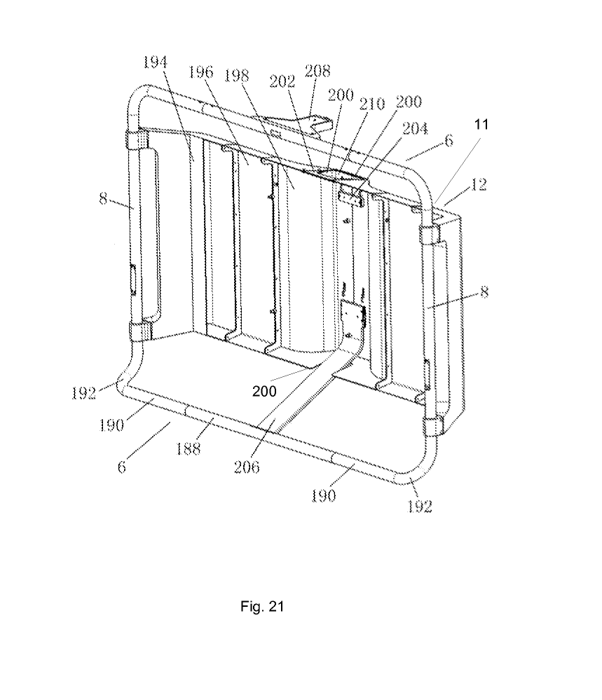

FIG. 21 illustrates an exemplary frame 2 consistent with the disclosed embodiments. As shown in FIG. 21, the first bar 6 may include a central bar 188, and an adjustment bar 190. The adjustment bar 190 may be connected to the second bar 8 through a connecting bar 192. The central bar 188, the adjustment bar 190, and the connecting bar 192 may be detachably attached to each other. In certain embodiments, two accessory bars (not shown) may be used to attach the central bar 188, the adjustment bar 190, and the connecting bar 192. The first end of the first accessory bar may be disposed in the central bar 188, and the second end may be disposed in the adjustment bar 190. A fastener may be used to securely attach the central bar 188 and the adjustment bar 190. The first end of the second accessory bar may be disposed in the connecting bar 192, and the second end may be disposed in the adjustment bar 190. A fastener may be used to securely attach the connecting bar 192 and the adjustment bar 190. When necessary, the fasteners may be removed to replace an adjustment bar 190 with different size.

As shown in FIG. 21, a back cover 11 may be disposed at the back side of the frame 2 between the two second bars 8. The back cover 11 may prevent the accumulation of dust and protect the components of the medical monitor. The back cover 11 may include two covers 12. The cover 12 may include a first cover 194, an adjustment cover 196, and a second cover 198. The first cover 194, the adjustment cover 196, and the second cover 198 may be detachably attached.

The two second cover 198 may be attached at the middle of the frame 2. At the top and bottom of the second cover 198, an indention 200 may be formed. In certain embodiments, the indention 200 may be in the shape of a letter “L.” The indention may also be in any appropriated shape. At the top of the second cover 198, a connecting member 202 may connect the two second cover 198. In certain embodiments, the connecting member 202 may be in the shape of the Chinese character “ [symbol] .” The connecting member 202 may also be in any other appropriate shape. After attaching the two second cover 198 together using the connecting member 202, an opening 210 is formed. The opening 210 may be configured to accommodate the supporting structure 4.

On the top of the frame 2, an attaching member 208 may be attached to the central bar 188 at one end, and may be attached to the supporting structure 4 at another end. In certain embodiments, the attaching member 208 may be in the shape of a letter “Y.” The attaching member may be in any appropriate shape. At the lower part of the two second covers 198, a strengthening member 206 may be attached thereto. The other end of the strengthening member 206 may be attached to the central bar 188. Thus, the frame 2 may be reinforced to carry large size monitor.

The frame 2 maybe used in systems 1A, 1B, 1C, and 1D. The frame 2 may also be used in a system consistent with the disclosed embodiments.

If the width of the monitor(s) attached to the frame 2 is relatively small, the adjustment bar 190 and the adjustment cover 196 may be removed. No adjustment bar 190 or a smaller adjustment bar 190 may be used between the central bar 188 and the connecting bar 192. Between the first cover 194 and the second cover 198, no adjustment cover 196 or a smaller adjustment cover 196 may be used. The medical monitor(s) with smaller size may be attached to the side bar 10. If the width of the monitor(s) attached to the frame 2 is relatively large, a larger adjustment bar 190 and/or a larger adjustment cover 196 may be used. Thus, the width of the frame 2 and the cover 11 may be adjusted for monitors with different sizes.

The components of the mounting systems 1A-1D may be made of any appropriate materials. The materials may be sufficiently strong to bear the weight of the monitor mounted on the systems. The materials may also be sufficiently light for the easy transportation of the systems. For example, the material may be aluminum, alloy, plastic, or any other appropriate materials. Each component of the systems may or may not be made of the same material.

The mounting systems consistent with the disclosed embodiments may offer certain advantages. A mounting system consistent with the disclosed embodiments may attach a monitor thereto with certain security, that is, it is unlikely that a monitor may fall from the mounting system. The system may be adjusted to accommodate monitors with different sizes. Further, the position of the monitor may be adjusted to reduce the gap between monitors and the blind spots in the visual field.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications. For example, the size, shape, and the number of the attaching member may be adjusted to accommodate different number of monitors with different size. The mounting system may also be used in other appropriate venue, for example, the display monitor in a school, a mall, a sport facility, or any other appropriate locates.

What is claimed is:

1. A monitor mounting system, comprising:
a supporting structure configured to be mounted at a location and to support the system;
a frame formed by two first bars and two second bars;
a side bar with a sliding groove with a mounting member attached therein, wherein the mounting member slides along the sliding groove and attaches a monitor to the side bar; and
a first attaching member configured to attach the side bar to the supporting structure.

2. The monitor mounting system according to claim 1, further including:
a sliding member disposed in the sliding groove;
a middle member with a first side attached to the sliding member; and
a monitor mounting member attached to a second side of the middle member, wherein the monitor mounting member includes a first part and a second part configured to attach a monitor, and a third part connecting the first part and the second part and being configured to attach the monitor mounting member to the middle member.

3. The monitor mounting system according to claim 2, further including:
a first fastener receiving member disposed on the sliding member;
a second fastener receiving member disposed on the top of the middle member;
a first opening disposed on the lower portion of the middle member;
a groove disposed on the top of the first part of the monitor mounting member;
a second opening disposed on the first part of the monitor mounting member;
a third opening disposed on the second part of the monitor mounting member; and
a fourth opening disposed on the third part of the monitor mounting member, wherein:
the groove, the second opening, and the third opening are configured to securely attach a monitor to the monitor mounting member.

4. The monitor mounting system according to claim 3, further including:
a coupling structure disposed on a side of a lower portion of the middle member, the coupling structure facing the sliding member, wherein:
the sliding member is partially disposed within the coupling structure.

5. The monitor mounting system according to claim 4, further including:
a first fastener configured to pass through the first opening to be received by the first fastener receiving member to attach the middle member to the sliding member;
a second fastener configured to pass through the fourth opening to be received by the second fastener receiving member to attach the monitor mounting member to the middle member.

6. The monitor mounting system according to claim 1, further including:
a fifth opening disposed at a back wall of the side bar.

7. The monitor mounting system according to claim 1, further including:
a back cover disposed between the second bars, wherein:
the back cover includes two covers.

8. The monitor mounting system according to claim 7, further including:
an opening on the back cover configured to allow the supporting structure to pass through;
a second attaching member disposed on the first bar on the top to attach the first bar to the top of the supporting structure passing through the opening; and
a strengthening member attached to the lower portion of the back cover and attached to the first bar at the bottom.

9. A monitor mounting system, comprising:
a supporting structure configured to be mounted at a location and to support the system;
a frame formed by two first bars and two second bars;
a side bar with a mounting member disposed at an end of the side bar, wherein the mounting member includes a first attaching member and a first positioning member; and
a second attaching member configured to attach the side bar to the supporting structure; wherein:
the first attaching member includes two first supporting member, a second supporting member perpendicular to the first supporting member;
a hanging structure and a recess are disposed on the first supporting members; and
the positioning member is attached to the side bar at a first end of the positioning member, and contacts the hanging structure at a second end of the positioning member.

10. The monitor mounting system according to claim 9, wherein:
the monitor mounting system has two second attaching members and two side bars, wherein:
the two side bars are attached to the two first attaching members by disposing the end of the two side bars in the hanging structure.

11. The monitor mounting system according to claim 10, wherein:
a first dimension of an opening of the hanging structure is smaller than a second dimension of a base of the hanging structure.

12. The monitor mounting system according to claim 9, further including:
a first part disposed on the positioning member, the first part having a top portion and a bottom portion, the top portion and the bottom portion being in the shape of rectangle, the top portion being smaller than the bottom portion;
a second part connected to the first part; and
a positioning structure disposed on the side bar.

13. The monitor mounting system according to claim 12, further including:
a first opening disposed on the positioning member;
a first fastener receiving member disposed on the positioning structure; and
a fastener configured to pass through the first opening to be received by the first fastener receiving member to securely attach the positioning member to the side bar, wherein:
the second part of the positioning member contacts the bottom of the hanging structure.

14. The monitor mounting system according to claim 9, further including:
a back cover disposed between the second bars, wherein:
the back cover includes two covers.

15. The monitor mounting system according to claim 14, further including:
an opening on the back cover configured to allow the supporting structure to pass through;
a third attaching member disposed on the first bar on the top to attach the first bar to the top of the supporting structure passing through the opening; and
a strengthening member attached to the lower portion of the back cover and attached to the first bar at the bottom.

16. A monitor mounting system, comprising:
a supporting structure configured to be mounted at a location and to support the system;
a frame formed by two first bars and two second bars;
two side bars attached to the supporting structure;
a movable mounting member disposed at an end of the side bar; and
a back cover with two covers disposed between the second bars.

17. The monitor mounting system according to claim 16, comprising:
a central bar; and
an adjustment bar attached to an end of the central bar, wherein:
the central bar and the adjustment bar form the first bar.

18. The monitor mounting system according to claim 16, further including:
a first cover;
a second cover; and
an adjustment cover, wherein:
the first cover, the second cover and the adjustment cover form the cover.

19. The monitor mounting system according to claim 16, further including:
an attaching member;
a sliding member configured to slide along the side bar;
an angle adjustment member to connect the attaching member and the sliding member;
a sliding groove disposed longitudinally along the side bar, wherein an end of the sliding member is disposed in the sliding groove, and
a monitor attaching member securely attached to the middle of the side bar.

20. The monitor mounting system according to claim 19, further including:
an upper portion;
an lower portion; and
a rotating member having a shaft, a disc disposed on the top of the shaft, wherein:
the shaft securely attaches to the lower portion and connects the upper portion and lower portion together;
the monitor attaching member is attached to the upper portion;
the lower portion is attached to the sliding member; and
the sliding member is attached to the side bar.
